(19) United States
(12) Patent Application Publication
(10) Pub. No.: US 2014/0218518 A1
(43) Pub. Date: Aug. 7, 2014

(54) Firearm Discharge Detection and Response System

(71) Applicant: James Oliver, Monee, IL (US)

(72) Inventor: James Oliver, Monee, IL (US)

(21) Appl. No.: 14/172,656

(22) Filed: Feb. 4, 2014

Related U.S. Application Data
(60) Provisional application No. 61/760,208, filed on Feb. 4, 2013.

(51) Int. Cl. G08B 25/00; H04N 7/18

(52) U.S. Cl. CPC G08B 25/00; H04N 7/181
USPC 348/143; 340/540

(57) ABSTRACT

A firearm discharge detection system includes a sensor array to detect gunshots, a communication interface between the sensor array and a controller, and a telecommunications module to transmit data to emergency responders. A method of facilitating a response to a firearm discharge, includes detecting the firearm discharge by a sensor, sending, in response to the detected firearm discharge, a detection signal from the sensor to a controller, transmitting, in response to the detection signal, a message to a law enforcement response center, wherein the message includes a link to a live camera feed. The link may also include a control panel screen.

### CROSS REFERENCE TO RELATED APPLICATIONS

This utility patent application filed under 35 USC §111 claims priority to U.S. provisional patent application 61/760,208 filed on Feb. 4, 2013, which is incorporated by reference herein.

### TECHNICAL FIELD

This invention relates generally to a system for detecting and warning of a firearm discharge. More particularly it relates to a device which detects the discharge of a firearm inside or outside of a building and once detected issues a warning to police and the occupants of the building.

### BACKGROUND

The prevalence of violent behavior with firearms appears to be an ever increasing threat. It is common occurrence to have people with mental and emotional health issues that have easy access to firearms and limited access to mental health care. These, individuals for known or unknown reasons, may threaten harm or actually start shooting or killing people in public spaces and buildings.

While the danger to employees, visitors, and occupants of a building from an individual discharging a firearm is extreme, currently there are no systems that have been deployed to detect a firearm discharge and to warn building occupants of the danger. Instead, there have been legislative efforts to reduce the number of ammunition rounds that can be held in a firearm magazine and/or to increase the presence of police or armed security officers in public building such as schools. Unfortunately, even police officers and security staff are not safe in these situations as they may become the first targets of a deranged shooter.

In many of these shootings, time is a critical factor. Once the shooter starts firing, he or she may not stop until he becomes aware of a massive police response. In that case, the shooter may decide to surrender and/or to take his life.

### SUMMARY

A need exists for a system that will detect the discharge of a firearm inside of a building and identify the position of that discharge inside the building. The system should also be capable of warning occupants of the building in the event of such a firearm discharge. Police will be alerted and the position of the shooter may be continuously updated.

As another feature, portions of building may be automatically locked down to prevent access. In this embodiment, an override feature may be available for authorized persons to have access.

The system can be easily installed and operated for the detection of a firearm discharge inside or outside of a building or structure. The system monitors constantly monitor the area proximate to installation in and around a building. Each detector may detect the discharge of a firearm by the noise level or sonic wave that a firearm transmits on discharge.

Once the detector has determined that a firearm has been discharged in the proximity of the detector, a signal is sent to a controller. The controller sends out alarm warnings to employees and other occupants of the monitored building that a firearm has been discharged. The controller instructs alarms to go off throughout the building. The alarm would be audible or visible or both and would warn persons in the proximity of the detector units and in the area a gunshot has been detected by another detector in the building and to exit the building or follow security procedures to secure the building.

The audible alarm could be a recorded voice warning of a gunshot detection. Additionally, the alarm may be visible in the form of a flashing light or lights on each detector.

A message is transmitted to police or security personnel of the discharge of a firearm in the monitored building and the exact location of the discharge. This could be performed by the controller using available telecommunications equipment such as telephone or wireless broadcast.

In one embodiment, the system detects the audible sound or shockwave from a firearm discharge. Sound waves monitored by a transducer are communicated through filters which only pass signals at certain frequency and decibel levels. In another embodiment, an optical sensor detect a muzzle flash.

The detector will then transmit a signal to the controller which will activate all the other detectors mounted in the building to sound the alarm and concurrently communicate a signal to police or security personnel of the discharge.

As another feature, the system may track heat signatures of people near the location of the firearm discharge. In that way, the location of potential shooter may be tracked and deliver to police or security in real time.

In another general aspect, a firearm discharge detection system includes a sensor array to detect gunshots, a communication interface between the sensor array and a controller, and a telecommunications module to transmit data to emergency responders.

The system may include one or more of the following features. For example, the sensor array may include acoustic sensors, optical sensors, thermal image sensors and motion detectors. As another feature, positioning modules may be used to detect the location of the discharged firearm.

A loudspeaker may send out audible communication to persons in the vicinity of a detected gunshot. A display device can display information to an administrator, emergency responder or other user. A human presence detection system may be used to identify the potential shooter or shooting suspect and a tracking system to track the geographic location of the detected human presence.

In another general aspect, a method of facilitating a response to a firearm discharge, includes detecting the firearm discharge by a sensor, sending, in response to the detected firearm discharge, a detection signal from the sensor to a controller, transmitting, in response to the detection signal, a message to a law enforcement response center, wherein the message includes a link to a live camera feed. The link may also include a control panel screen.

The method may include one or more of the above or following features. For example, distance and direction of the firearm discharge may be detected by more than one sensor of the sensor array to determine the location of the firearm discharge. A shooting suspect may be identified with a camera in proximity to the location of the firearm discharge. The features of the shooting suspect may be analyzed so that the shooting suspect can be re-identified by other cameras in the system.

The system may display a building layout with the current and previous locations of the shooting suspect. As another feature, locations of emergency responders relative to the building layout may also be displayed. As another feature, the message with the link to the live camera feed may be sent to emergency responders within a geographic range of the firearm discharge. As a traffic safety feature, access to the live camera feed may be blocked when the emergency responder is a one man vehicle that is not in a stationary position.

### BRIEF DESCRIPTION OF THE SEVERAL VIEWS OF THE DRAWINGS

FIGS. 1 and 2 illustrate system diagrams for the firearm discharge detection system; and

FIGS. 3-7 illustrate administrator panels for the system.

### DESCRIPTION

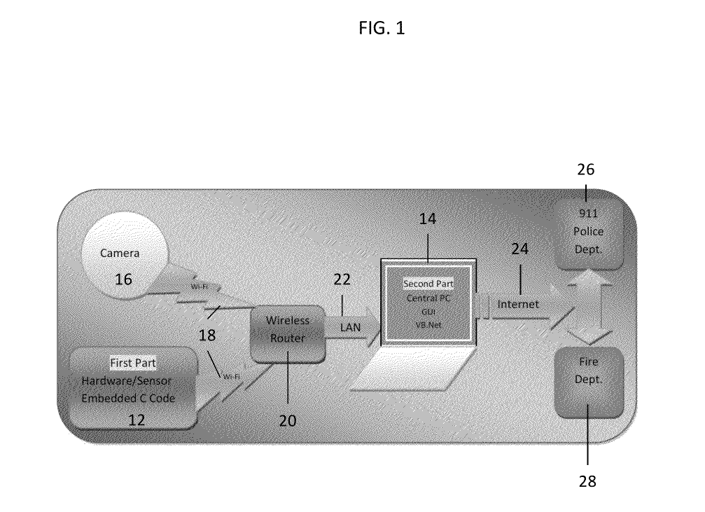

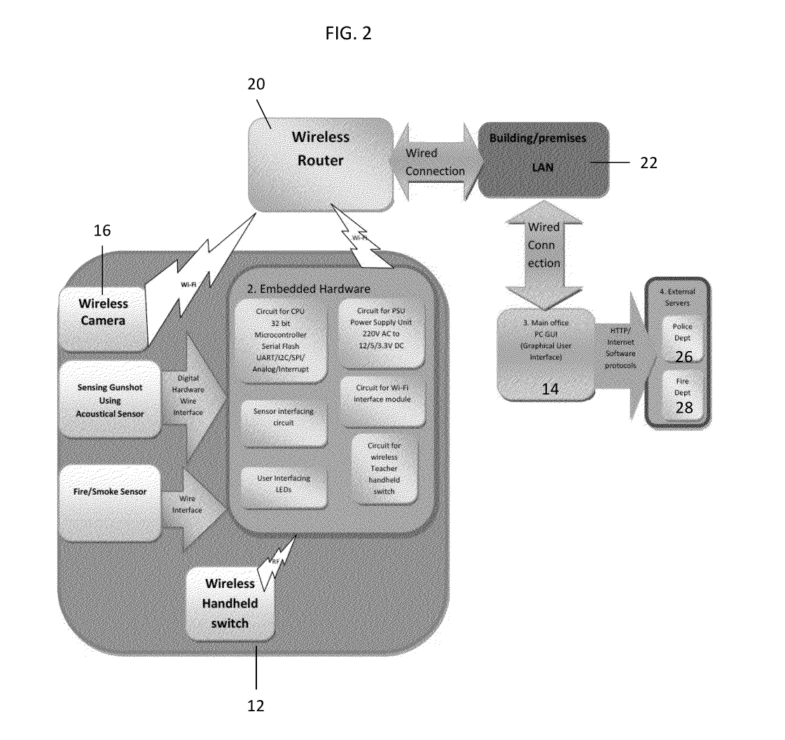

FIG. 1 illustrated a system diagram is a depiction of the system 10 showing the components and interaction thereof.

The system features at least one detector, sensor (acoustical, thermal image or optical) 12 or a sensor array mounted in a structure in a location remote to a controller 14. Each sensor 12 may be powered by a battery or alternating current (AC) power or a combination thereof to protect the system from power outages.

The detectors 12 have features to detect a firearm sound discharge from the decibel level and duration of the sonic wave generated by the firearm which is located inside each sensor 12 which receives electronic signals representative of the decibel level and duration of sounds proximate to the sensor 12 from, for example, a microphone or transducer that continually monitors the area proximate to the location of the detector.

Decibel levels of the sound or shock wave that are monitored by the transducer are communicated to the firearm discharge detector. A signal filter may check for comparison with what would be measured by a firearms discharge. The hardware and software of the firearm arm discharge detector may be built into the sensor 12.

A camera 16 is installed in the proximity of each sensor 12. The sensor 12 and camera 16 have wireless connections 18 to the controller 14. More specifically, these components are part of a wireless local area network that transmit WiFi signals to a wireless router 20 which communicates with the controller 14 over a local area network (LAN) 22.

Receipt of the signal from a tripped sensor 12 alerts the controller 14 that the sensor has detected a firearm discharge in its proximity. The sensor can also initiate an audible alarm means and a visible alarm. The controller 14 and each sensor 12 may be powered by conventional power means such as a battery or AC power or a combination thereof which would protect the system from power outages.

When the signal of a firearm discharge is received, the controller activates the other detectors in the building to broadcast audible and/or visual alarms. A speaker can broadcast an audible alarm or warn of a firearm discharge. The audible warning can be either a noise such as a beeper or buzzer, and/or a recorded voice message to warn occupants. A visible warning may include a light emitting diode or a flashing strobe light.

Communication between the detectors and the controller could be provided by wires or a wireless communication network. Two way communication may be accomplished using an existing computer network by new installation.

The controller 14 can identify the specific location of the sensor in the building. For example, a location code can be stored a memory storage device. A location receiving device, such as, for example, global positioning system (GPS) modules could be located in each sensor 12 to transmit positioning information that could be used to determine the exact location by storing the coordinates determined on installation with the controller's memory.

Information about the relative strength of the sound received may also determine which detector is closest to the incident. Since the controller 14 would essentially be a computer, memory storage and software operation would be in the format of a conventional personal computer widely used for such purposes. The controller 14 could also be a specially engineered computer housed in a small housing with the onboard memory, operating system, and communications components.

Upon the determination of any installed sensor that a firearm has been discharged, the sensor will trip and communicate that information to the controller along with the onboard information about the location in the building.

In one embodiment, a sensor array is used with known distances and locations of each sensor 12. Each sensor 12 can record the sound level and the direction of the sound. By a process of triangulation of each the sound level and direction of the sound, the location of the shooter can be pinpointed. The controller 14 can use that information to track the shooter as he moves to another location.

The controller transmits signals to emergency responders over a telecommunication network, such as, for example, the Internet 24. The emergency responders may be a 911 emergency center that routes the call to police or fire dispatchers 26, 28.

FIG. 2 shows a more detailed system diagram. A gunshot sensor may be an acoustic sensor and a separate fire and smoke detector may be part of the sensor 12. The fire and acoustic sensors communication with embedded hardware 30 by way of wire interfaces 32. The embedded hardware 30 may include a CPU circuit 34, a sensor interfacing circuit 36, user interace LEDs 38, a power supply circuit 40, a WiFi interface module 42, and a circuit for a wireless remote circuit 44.

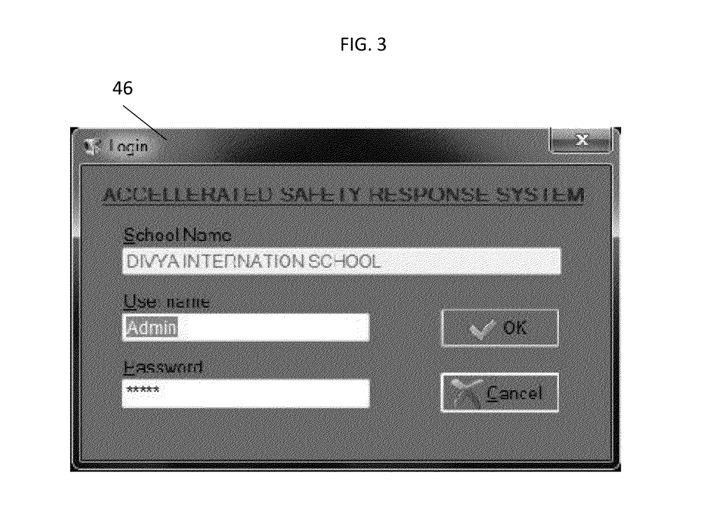

FIG. 3 shows a login panel 46 for a system administrator. The administrator enters a building site, such as, for example, a school name. A username and password are also entered for purposes of logging in.

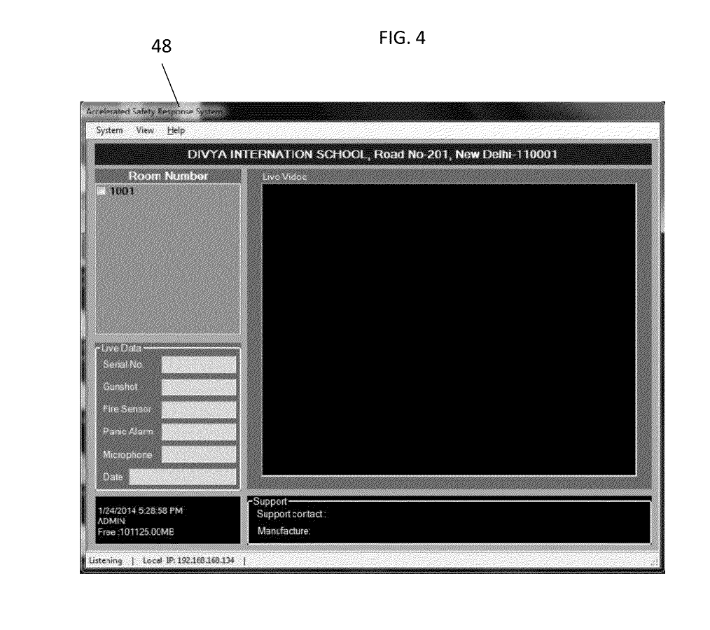

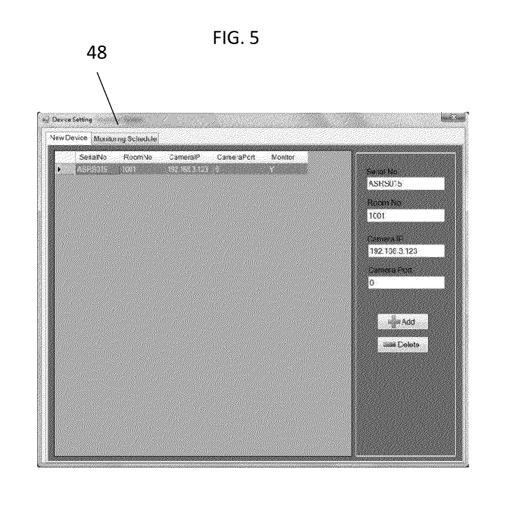

FIGS. 4-5 show display panels 48 for the administrator. The display panel allows the operator to enter information to configure and set up the system. For example, data is assigned to each location such as room information, sensor serial number, IP address, etc.

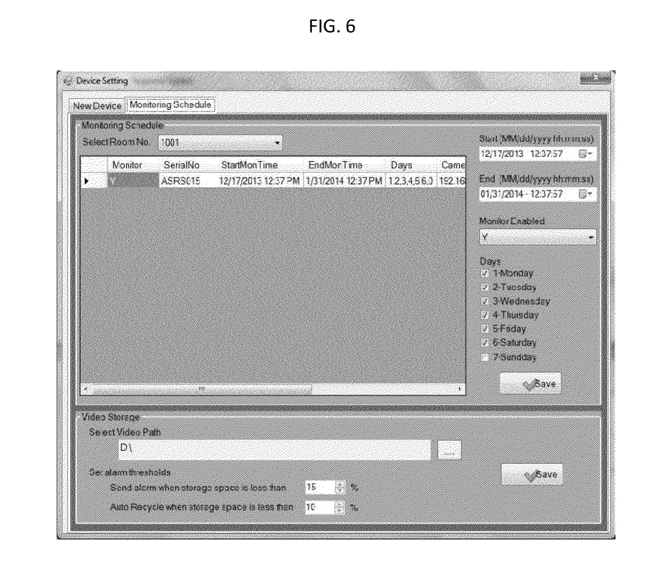

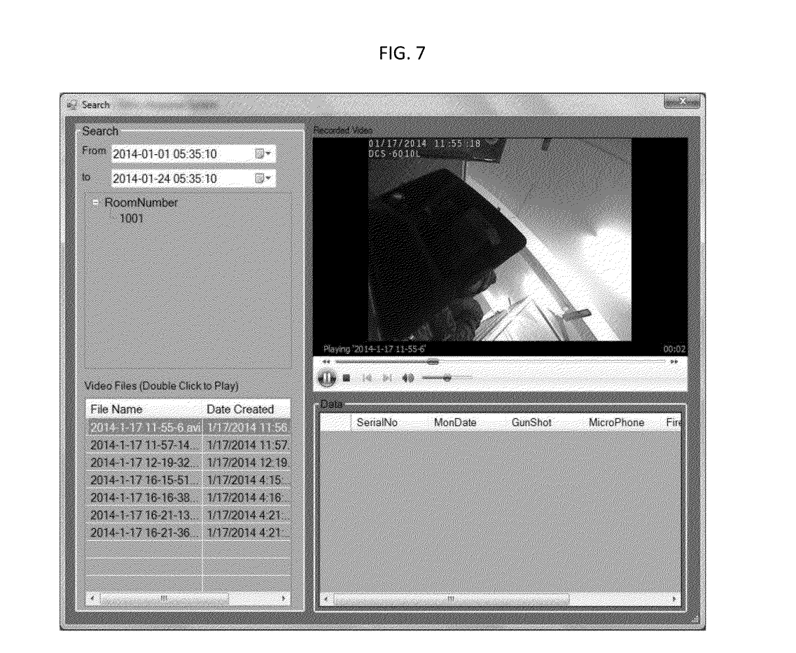

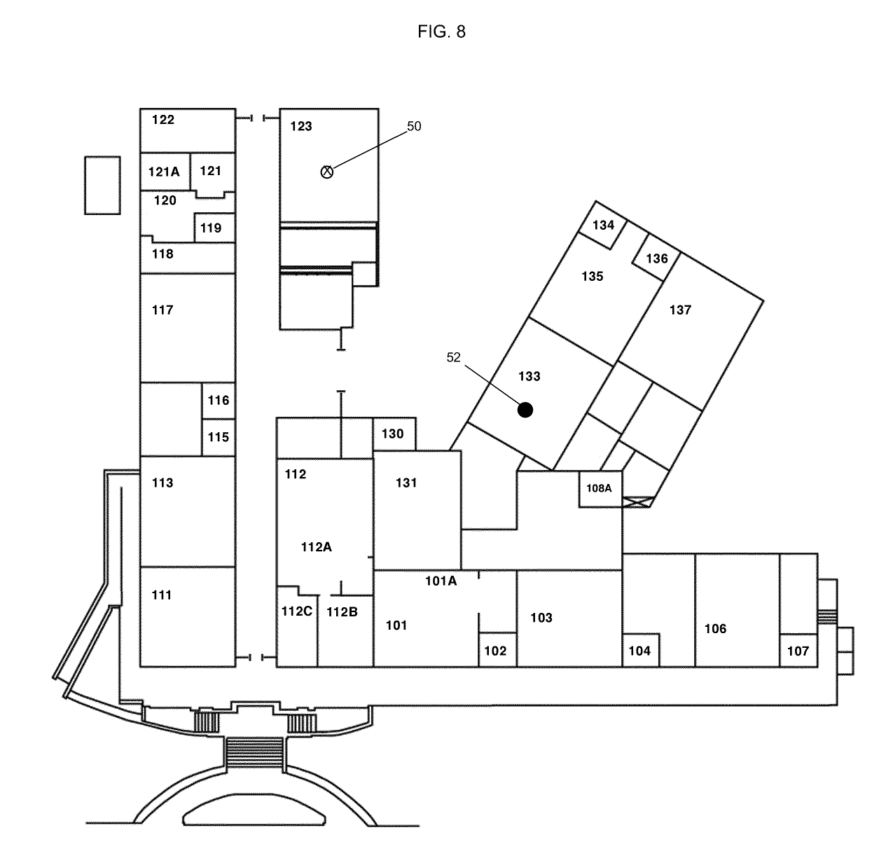

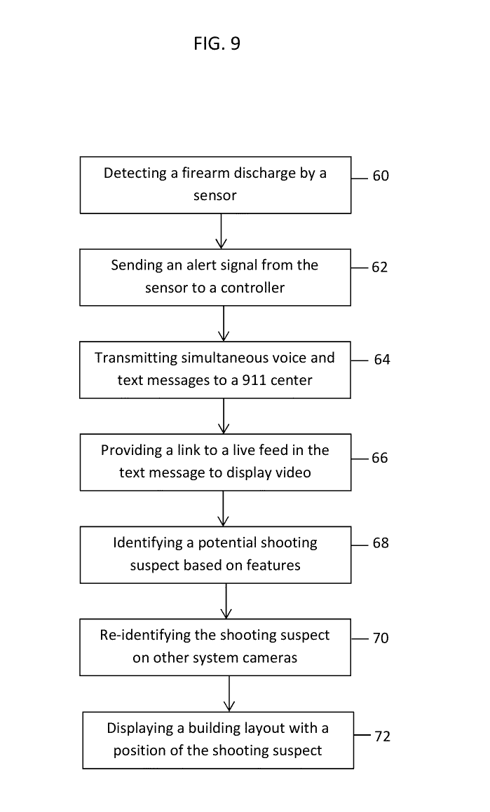

FIG. 6 shows a display panel that allows the administrator to set up a monitoring schedule. FIG. 7 shows a display panel to allow the administrator to review information stored data such as video recordings.

In operation, a sensor 12 picks up a firearm discharge and transmits a signal to the controller 14. The controller 14 sends a recorded message to the 911 center and a text message is simultaneously transmitted to the 911 center that includes a hyperlink. The 911 center can open the hyperlink and can immediately view a live camera feed of a camera in closest proximity to the sensor 12.

In one embodiment, the multiple sensors pick up the firearm discharge and can target individuals who may have discharged the firearm. Features of one or more shooting suspects are analyzed by the controller. These features are stored and each camera in the system can be used to re-identify the suspect. Thus, the shooting suspect can be tracked by the cameras as he moves throughout the building.

Referring to FIG. 8, the 911 center can display a building layout that shows location of the firearm discharge 50 and the current location 52 and previous locations of the shooting suspect. As another feature, the positions of tactical team members can also be identified on the display of the building layout.

As another feature, the text message with the link can be sent to an on-scene command center and/or to police units responding to the emergency. Thus, each office can have a view of the situation internally.

The system can be set up to provide the hyperlink to police units within a geographic area. As a traffic safety feature, the system may not transmit the hyperlink to a one person police unit while that officer is moving.

FIG. 9 illustrates a method of responding to a firearm discharge by a shooting suspect. In operation 60, a firearm discharge is detected by a sensor. The sensor, which has its own embedded hardware, sends an alert signal to a controller 62.

In operation 64, the controller simultaneously transmits voice and text messages to a 911 center. The text message includes a link to a live video feed so that the emergency responder can view the situation adjacent to the location of the firearm discharge 66.

Data from the camera feed is analyzed by the controller to identify a shooting suspect in operation 68. As the shooting suspect moves through a building, he is re-identified by other system cameras 70. The emergency responder has the ability to display a building layout with a position of the shooting suspect in operation 72.

The firearm discharge response system described above may be embodied in one or more module which is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application and implemented by at least one processor of a computing device.

The firearm discharge response system has been described through specific embodiments, but should not be confined or limited to these examples. A person with ordinary knowledge in the field to which the present invention belongs can use the technical concepts to modify the present invention. Thus, the present invention includes the scope of the following claims and its equivalents.

1. A firearm discharge detection system, comprising:
a sensor array to detect gunshots;
a controller that receives a signal from the sensor array and sends a simultaneous text and voice message to one or more emergency responder via the telecommunications module; and
a telecommunications module to transmit and receive data between the controller and the emergency responder.

2. The firearm discharge detection system of claim 1, wherein the sensor array comprises acoustic sensors.

3. The firearm discharge detection system of claim 1, further comprising:
a positioning module to detect the location of the discharged firearm.

4. The firearm discharge detection system of claim 1, further comprising:
an optical sensor.

5. The firearm discharge detection system of claim 1, further comprising:
a motion detector.

6. The firearm discharge detection system of claim 1, further comprising:
a thermal image sensor.

7. The firearm discharge detection system of claim 1, further comprising:
a loudspeaker to send out audible communication to persons in the vicinity of a detected gunshot.

8. The firearm discharge detection system of claim 1, further comprising:
a display device to display information to a user.

9. The firearm discharge detection system of claim 8, further comprising:
a human presence detection module to identify a potential shooting suspect.

10. The firearm discharge detection system of claim 9, further comprising:
a tracking module to track the geographic location of the shooting suspect.

11. A method of facilitating a response to a firearm discharge, comprising:
detecting the firearm discharge by a sensor;
sending, in response to the detected firearm discharge, a detection signal from the sensor to a controller; and
transmitting, in response to the detection signal, a simultaneous text and voice message to a law enforcement response center, wherein the text message includes a link to a live camera feed.

12. The method of claim 11, further comprising:
detecting a distance and direction of the firearm discharge by more than one sensor of the sensor array to determine the location of the firearm discharge;
identifying one or more shooting suspect with a first camera based on proximity to the location of the firearm discharge;
analyzing features of the one or more shooting suspect;
reidentifying the shooting suspect at a location of a second camera based on the analyzed features.

13. The method of claim 12, further comprising:
displaying a building layout with the current and previous locations of the shooting suspect.

14. The method of claim 13, further comprising:
displaying a location of emergency responders relative to the building layout.

15. The method of claim 11, wherein the link further includes a control panel screen.

16. The method of claim 11, further comprising:
sending the message with the link to the live camera feed to emergency responders within a geographic range of the firearm discharge.

17. The method of claim 16, further comprising:
blocking access to the live camera feed when the emergency responder is a one man vehicle that is not in a stationary position.
